(19) United States
(12) Patent Application Publication
(10) Pub. No.: US 2024/0261861 A1
(43) Pub. Date: Aug. 8, 2024

(54) METHOD AND APPARATUS FOR ADDITIVE MANUFACTURING

(71) Applicant: Eaton Intelligent Power Limited, Dublin, 4 (IE)

(72) Inventors: Catriona CLARKE, Kildare (IE); Sourav DUTTA, Dublin, 15 (IE)

(21) Appl. No.: 18/566,495

(22) PCT Filed: Jun. 2, 2021
(86) PCT No.: PCT/EP2021/064870

§ 371 Date: Dec. 4, 2023

(51) Int. Cl. B22F 10/34; B22F 10/85; B33Y 50/02; B33Y 80/00; G05B 19/4099

(52) U.S. Cl. CPC B22F 10/34; B22F 10/85; B33Y 50/02; B33Y 80/00; G05B 19/4099; B22F 2203/03; G05B 2219/49023

(57) ABSTRACT

A method of additive manufacture of a constituent part of an item is described. The method comprises the following steps. A specification of characteristics is provided for the constituent part. A composition determination system is then used to identify a composition comprising a plurality of component materials predicted to comply with the specification of characteristics. The composition determination system is a system trained using a database of known materials. The constituent part of the item is then manufactured according to the composition identified by the composition determination system using an additive manufacturing system. Items may be manufactured with a plurality of constituent parts each manufactured this way. A method of establishing a computer-implemented composition determination system for manufacture of items and a control system for additive manufacture of an item using heterogeneous materials by an additive manufacturing system are also described.

### TECHNICAL FIELD

The disclosure relates to method and apparatus to support additive manufacturing. In addition to methods and apparatus for additive manufacturing, methods and apparatus for determining material compositions for use in additive manufacturing are described.

### BACKGROUND

In order to meet particular requirements in manufacture, such as achieving a particular set of physical properties, it may be necessary to use complex materials when no simple material has the right set of properties. A manufactured item may need to have specific values or ranges for one or more physical or chemical properties—such as, say thermal conductivity, melting point, flexural strength, and flexural modulus—and the most effective way to achieve a given set of such properties may be to use an optimised mixture of components. This may be considered to be a heterogeneous material formed from a set of homogeneous materials. A complex manufactured item may even require different physical properties in particular properties in particular regions of the item.

Developing or choosing complex or heterogeneous materials for such purposes is currently a slow and iterative process, requiring expert knowledge, time, and cost intensive testing and feedback. It is against this background that this disclosure is made.

### Summary of Disclosure

In a first aspect, the disclosure provides a method of additive manufacture of a constituent part of an item, comprising: providing a specification of characteristics for the constituent part; using a composition determination system, wherein the composition determination system is a system trained using a database of known materials, to identify a composition comprising a plurality of component materials predicted to comply with the specification of characteristics; and manufacturing the constituent part of the item according to the composition identified by the composition determination system using an additive manufacturing system.

Using this approach, a heterogeneous material composition can be identified for a constituent part of an item to achieve a particular set of properties. This composition can then be used in an additive manufacturing process to construct the constituent part of the item.

In embodiments, for the composition identified for manufacturing the constituent part, further materials properties are established by the composition determination system. These further materials properties can then be used for determining settings for the additive manufacturing system. For example, thermal conductivity and tensile strength may be properties used to determine a particular composition, but the melting point may be another property identified for that composition. The melting point may then be significant in determining settings of the additive manufacturing system used to manufacture the constituent part of the item.

The item may comprise a plurality of constituent parts, wherein the method comprising identifying the composition for each of the constituent parts and manufacturing each of the constituent parts of the item according to the composition identified for that constituent part. In such a case, the item may be manufactured in a plurality of layers, with each constituent part forming one or more of the layers. The item may be a component, such as a heatsink.

The additive manufacturing system may comprise a mixer for mixing the component materials in proportions according to the composition, and a fusing technology for fusing the component materials to form an item. The additive manufacturing system may further be adapted to feedback properties of manufactured constituent parts in relation to predicted properties for those constituent parts into determining settings for the additive manufacturing system for manufacturing future constituent parts.

In embodiments, the composition determination system is trained using one or more machine learning techniques.

In a second aspect, the disclosure provides an additive manufacturing system adapted to perform a method of additive manufacture as set out in the first aspect.

In a third aspect, the disclosure provides a method of establishing a computer-implemented composition determination system for manufacture of items, the method comprising: establishing a materials database where each entry comprises a material composition from a set of component materials and associated properties for the material with that material composition; using a machine learning system to train a composition property model using data from the materials database; testing the composition property model using data from the materials database; optimising the composition property model until it is adapted to predict associated properties for an arbitrary material composition; and establishing a user interface for determination of a composition of a constituent part of an item using the composition property model for input values for properties of that constituent part.

In this case, optimising the composition property model may comprise adjusting the hyperparameters of the model. Optimising the composition property model may also comprise further training and testing the model using data from manufactured items.

In a fourth aspect, the disclosure provides a composition determination system for manufacture of items established according to the method of the third aspect.

In a fifth aspect, the disclosure provides a control system for additive manufacture of an item using heterogeneous materials by an additive manufacturing system, the control system comprising: a composition input for receiving a composition of component materials for one or more constituent parts of the item and a set of associated properties for the composition from a composition determination system, wherein at least some of the associated properties are specified properties for the constituent part or parts of the item; a materials output for instructing provision of the component materials for provision to a mixer of the additive manufacturing system in accordance with the composition; and setting determination means adapted to determine settings of the additive manufacturing system based on the composition and the associated properties for the composition, and to provide those settings as an output to the additive manufacturing system.

This control system may be further adapted for additive manufacture of an item comprising a plurality of constituent parts, wherein the setting determination means may then be further adapted to adjust settings of the additive manufacturing system based on differences between the composition and associated properties of the composition of the current constituent part and the composition and associated properties of the composition of a preceding constituent part. In embodiments, the setting determination means may be further adapted to adjust settings of the additive manufacturing system based on a difference between actual associated properties and predicted associated properties of an constituent part manufactured by the additive manufacturing system according to a composition received from the composition determination system.

In a sixth aspect, the disclosure provides an additive manufacturing system comprising the control system of the fifth aspect.

### BRIEF DESCRIPTION OF FIGURES

Embodiments of the disclosure will now be described, by way of example, with reference to the following figures, in which:

FIG. 1 is a schematic diagram of apparatus for a composition determination system;

FIG. 2 is a flowchart representing a method for producing the composition determination system of FIG. 1;

FIG. 3 is a flowchart representing a method of using the composition determination system of FIGS. 1 and 2;

FIG. 4 is a schematic diagram of apparatus for performing additive manufacturing in conjunction with the composition determination system of FIGS. 1 to 3; and

FIG. 5 is a flowchart representing a method of additively manufacturing a component using the apparatus of FIG. 4.

### DETAILED DESCRIPTION

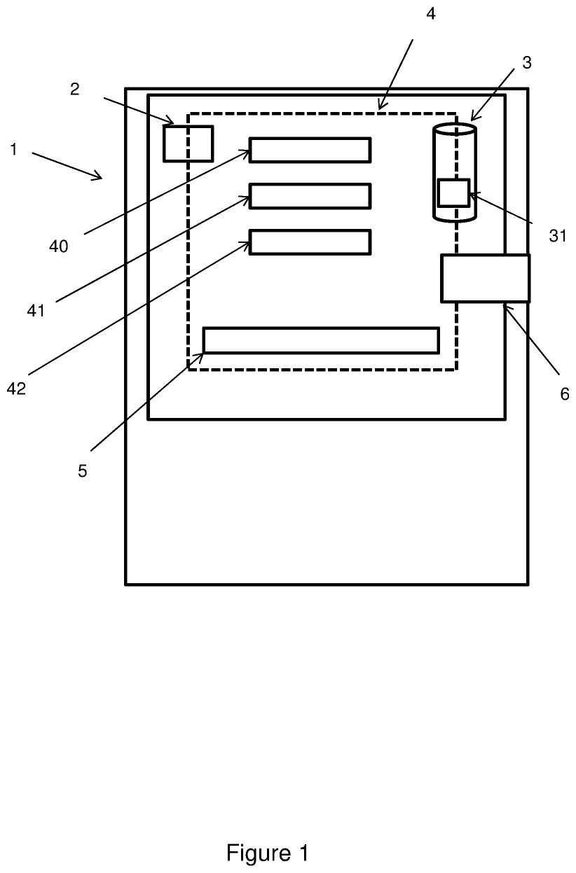

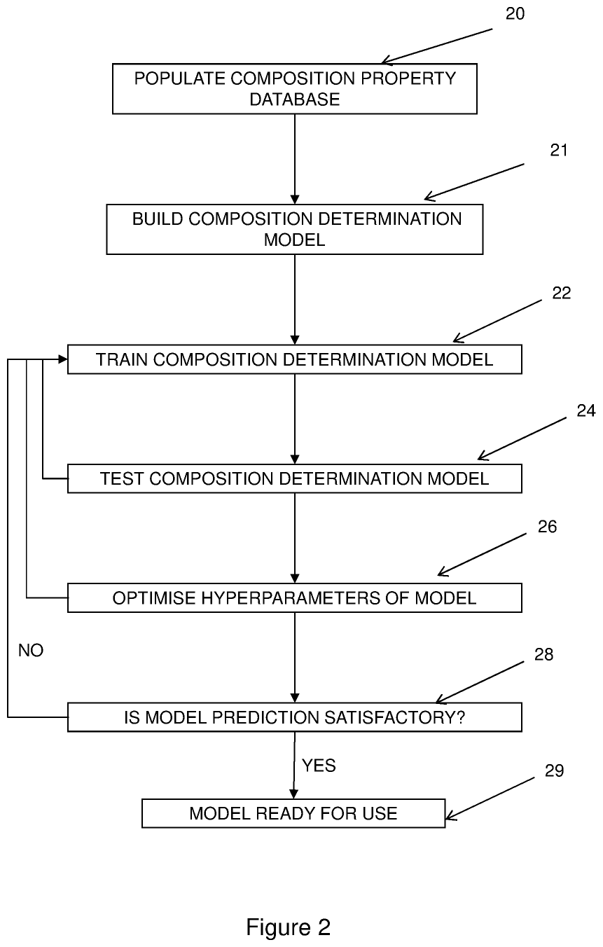

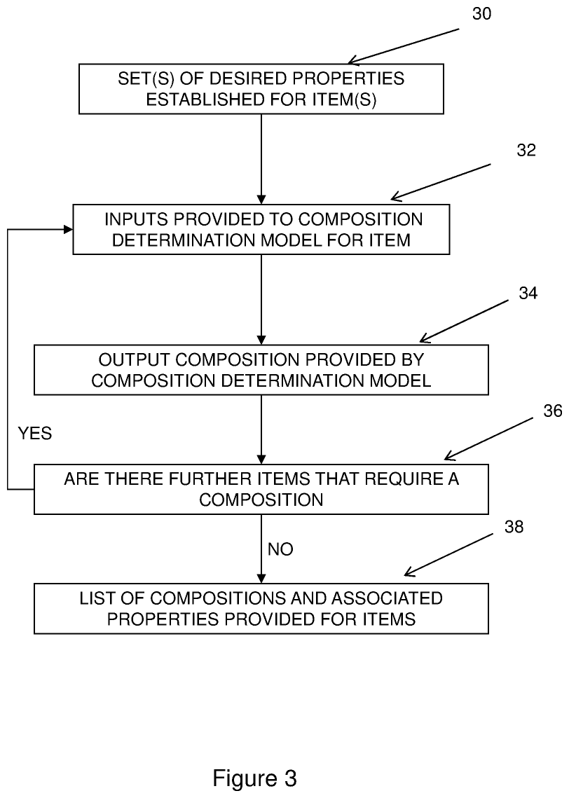

In embodiments, the disclosure provides methods and apparatus for determining material compositions for use in additive manufacture. These will generally be heterogeneous compositions formed from some combination of homogeneous materials. Suitable apparatus for providing a composition determination system is shown in FIG. 1, with a method of producing a composition determination system shown in FIG. 2 and a method of using such a composition determination system shown in FIG. 3. As will be disclosed below, complex items may be constructed using this approach, with the complex items being composed of a plurality of heterogeneous constituent parts with different compositions.

FIG. 1 shows a computing system 1 adapted to act as a composition determination system for additive manufacturing processes. The computing system may be realised in a more complex or distributed computing system, but is shown here as one device for convenience, comprising a processor 2 and a memory 3 between them supporting a computing environment 4 under the control of an operating system 5 with a user interface 6. In addition to these general-purpose components, the computing environment 4 supports a machine learning system 40, a composition property model 41 and a composition determination program 42, and the memory 3 contains a composition property database 31.

The computing system 1 is here configured to act both to produce and refine a composition determination system, and also to use such a system. These functions can be separated into different computing systems, with one system used only to produce and refine the composition determination system for use, with the composition property model 41 and composition determination program 42 then exported to another computing system—such as an additive manufacturing control system—for operational use.

A process of producing a composition determination system is illustrated in FIG. 2. The first step is to populate a composition property database. This provides properties of known heterogeneous materials and their compositions. Composition is defined in terms of proportions of homogeneous constituents, with a heterogeneous material being comprised of a mixture of homogeneous constituents according to that defined composition used as input to an additive manufacturing process to form an item (which may be a product or a part of a product). Each entry in the database represents an item made according to a particular composition with resulting measured properties. The step of populating 20 the composition property database comprises for each entry providing a proportion of each of the homogeneous constituents used along with a value for each of the properties measured for the relevant item. This data needs to be cleaned for use—the data needs to be consistently presented and rendered in a form suitable for use by a machine learning system. Data will be most useful if a full set of properties of interest have been measured, but data that only has a partial set of measured properties may still be of value.

Not all the items will include all homogeneous ingredients—the broader the range of data from pure homogeneous ingredients and their properties across a wide range of mixtures of some or all of the homogeneous ingredients, the more effective at prediction the composition determination system is likely to be. Use of a pure homogeneous material may even be a possibility.

There may be a variety of different constituent materials used for the composition property model 41. For a part required to provide particular mechanical and thermal properties—such as tensile strength, tensile modulus, thermal conductivity, melting point, filler size, and so on—materials such as boron nitride, graphite and carbon nanofillers may be considered. In general, the constituent materials under consideration may be those that can readily be used in a particular additive manufacturing process, so that the compositions indicated by a particular composition property model will generally be manufacturable by a particular additive manufacturing process or system.

The next steps are to build 21 and to train 22 the composition property model 41 using the machine learning system 40. To do this, an appropriate machine learning system needs to be used—in principle, any machine learning model (such as regression techniques, support vector machines, neural networks or decision trees, or an ensemble approach using multiple models), with the actual choice made being appropriate to the nature of the data and the compositions and properties used (for example, a different model may be more appropriate to consideration of a small number of homogeneous materials than would be appropriate to a large number. Other artificial intelligence techniques may be used, rather than those limited to what are currently understood to constitute “machine learning”—for example, evolutionary algorithms could also provide the basis for effective embodiments of the disclosure. A part (typically 70-80%) of the set of data in the database will be used to train 22 the model, with the remaining part being used to test 24 the model. This is an iterative process, as is optimisation 26 of the model by adjustment of hyperparameters until it achieves 28 a satisfactory ability to predict on test data—at this point, the model can be considered to have achieved the status 29 of a working composition property model 41.

There may be a plurality of composition property models 41 established—rather than attempt to produce one extremely complex model for a large number of homogeneous materials, it may be desirable to create plural models for different subsets of the materials. This may be desirable, for example, if it is known that for certain purposes only a subset of possible materials would need to be used (in that it would be effective across the range of properties that would be needed and was known to be suitable for the purpose). This would allow simpler models to be used, which may be easier to train to predict effectively.

Use of the model to determine composition is set out in FIG. 3—this is carried out in this case by the composition determination program 42. A set of desired properties for an item is established 30. This item may be a whole component to be manufactured, or it may be a part of a component—in which case, there may be a plurality of items, each with their own set of desired properties. The set of desired properties for the first item is used as an input 32 to the composition property model 41 to be used, and as a result of the training, the composition property model 41 provides as an output 34 comprising a composition of the homogeneous materials used in the composition property model 41 to achieve the desired properties. This output 34 need not be limited to a composition—it may provide other properties predicted to be associated with that composition, for example a melting point for the composition as a mixture. These other properties may be used for determining the settings of additive manufacturing machinery.

It is then determined 36 whether there are further items needing a composition—if so, the process, goes back to the input step, but if all item compositions have been identified, the process stops. The final output 38 is a set of recipes, each for an item of the component, together with additional properties that may be used to determine additive manufacturing machinery settings. The additive manufacturing process may be such, as described below, that the items may be provided as discrete layers within a component—more complex arrangements are also possible. The component, however, is to be constructed according to a plan by which defined items within the component are provided as mixtures of homogeneous material ingredients in compositions determined for each item by the composition determination model, with other predicted properties being used for determining settings for additive manufacture.

The results of actual additive manufacture may then be measured for the properties used in the composition determination model, and these can be used to optimise the model further.

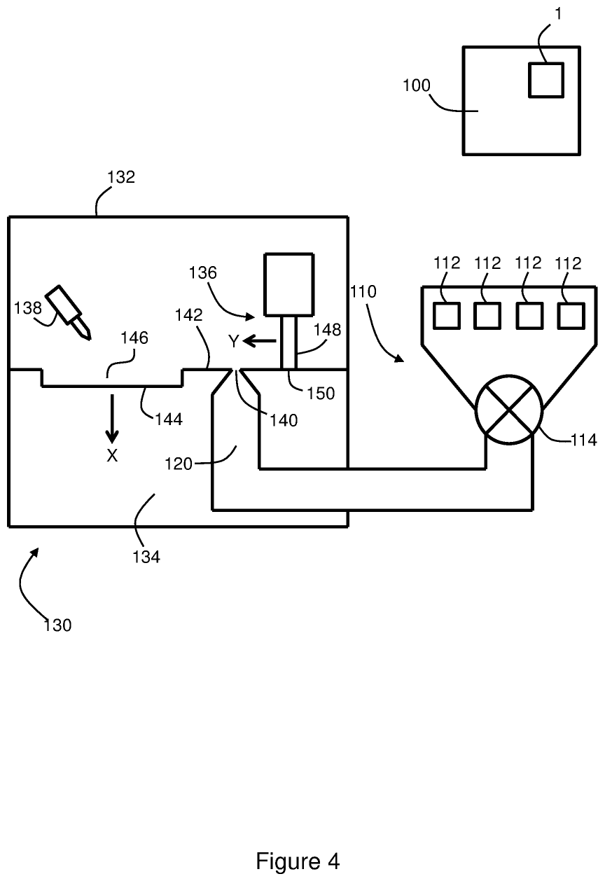

The disclosure also provides methods and apparatus for additively manufacturing a heterogeneous component. As can be seen in FIG. 4, the additive manufacturing apparatus comprises a mixer unit 110, a storage unit 120 and an assembly unit 130, which are both capable of receiving instructions from a control unit 100 that comprises the composition determination system 1 described above. The apparatus and method described below relate to additive manufacturing module for use with powdered materials, however, it will be appreciated that the principles underpinning this disclosure may equally relate to apparatus and a method for additive manufacturing using other classes of material, such as liquids and resins.

The mixer unit 110 comprises a plurality of bays 112, and a mixer module 114. The bays receive homogeneous constituent materials, which act as starter materials for the additive manufacturing process. Although starter materials are usually homogeneous materials, they may in some cases be a mix of two or more homogeneous materials in a predetermined ratio. In the case that the starter material is a mix of two or more homogeneous materials, it is important that the ratio of each of the homogeneous materials that comprise the starter material is well-defined, such that the material properties of the starter material can be similarly well-defined. As mentioned above, the starter materials in this case are powders but in other cases may be liquids or resins. Each individual bay 112 contains only one starter material. The bays 112 may be removable from the mixer unit 110 in order to load the starter materials into the mixer unit 110.

The bays 112 are configured to allow the starter materials to progress to the mixer module 114. This may occur in a number of ways, as will be obvious to the skilled person. For example, in the case of powdered starter materials, the mixer module 114 may be positioned below the bays 112 and each bay 112 may open from its base to cause the starter material to fall into the mixer module 114. The mixer module 114 comprises mixing apparatus that is suitable to mix the starter materials together, examples of which will be obvious to the skilled person.

The storage unit 120 is configured to store the newly mixed material after it has passed through the mixer module 114. In some embodiments, the storage unit 120 may act as a link between the mixer unit 110 and the assembly unit 130 and may in certain cases form part of the assembly unit 130. This allows the mixer unit 110 and assembly unit 130 to form part of the same overall structure. However, there is no requirement for this to be the case; the mixer unit 110 and assembly unit 130 may be provided as separate structures, with human or mechanical intervention required to transfer the mixed material produced by the mixer unit 110 to the assembly unit 130. In the case of powdered starter materials, the storage unit 120 may take the form of a container.

The assembly unit 130 comprises a housing 132, within which the rest of the assembly unit 130 is contained. The housing 132 comprises a base platform 134. The assembly unit 130 additionally comprises a coater module 136 and fusing apparatus 138. The assembly unit 130 allows the construction of additively manufactured heterogeneous components from the material mixed by the mixer unit 110. Continuing the above example given of a situation in which the starter materials are powders, the container 120 may be contained at least partially within the base platform 134 such that it opens out into the assembly unit 130 via a container aperture 140. The volume of the container 120 may be such that a small amount of the mixed material stored therein spills out of the container aperture 140 and onto an interior surface 142 of the base platform 134.

The base platform 134 comprises a build platform 144, which is capable of vertical movement relative to the rest of the base platform 134. Specifically, the build platform 144 may move vertically downwards relative to the rest of the base platform 134, as shown by arrow X to define a recessed build volume 146, which increases and decreases as the build platform 144 moves relative to the rest of the base platform 134. It is on the build platform 144 that components are manufactured, in use. Therefore, the maximum extent of downward movement of the build platform 144 defines a maximum build volume 146 for the component and so creates an upper bound to the size of the components that can be manufactured in the assembly unit 130.

The coater module 136 comprises a coater piece 148, which is configured to engage with the interior surface 142 of the base platform 134 via a contacting surface 150. The coater module 136 is configured to move within the housing 132 such that the coater piece 148 may be brought across the base platform 134, container aperture 140 and build platform 144 in the direction shown by arrow Y. It will be apparent to the skilled person that there are multiple ways in which the movement of the coater module 136 may be realised and that this is not of central importance to the concept described here. The contacting surface 150 of the coater piece 148 may vary in dimension but must at least be equal to the width of the build platform 140 transverse to the direction Y in which the coater piece is moved.

In use, the build platform 144 is moved downwards very slightly with respect to the base platform 134 to define a very shallow build volume 146. The coater module 136 is moved across the base platform 134. In so doing, it pushes the mixed material that has spilled over from the container 120 across the base platform 134, leaving a first build layer of the powdered mixed material on top of the build platform 134 in the build volume 144. Excess mixed material not retained in the build volume 144 is collected and returned to the container 120 to ensure maximum efficiency of use of the raw materials.

The fusing apparatus 138 comprises means to fuse together the mixed material on the build platform 144. Even in the case of powdered materials, it will be appreciated that the exact nature of the fusing apparatus 138 depends on the precise nature of the mixed material. For example, the fusing apparatus 138 may comprise a laser to fuse the mixed material by selective melting. Powdered mixed material may also be fused together by an adhesive applied by fusing apparatus 138 comprising an adhesive applicator. Other examples of fusing apparatus 138 will be well known by those skilled in the art.

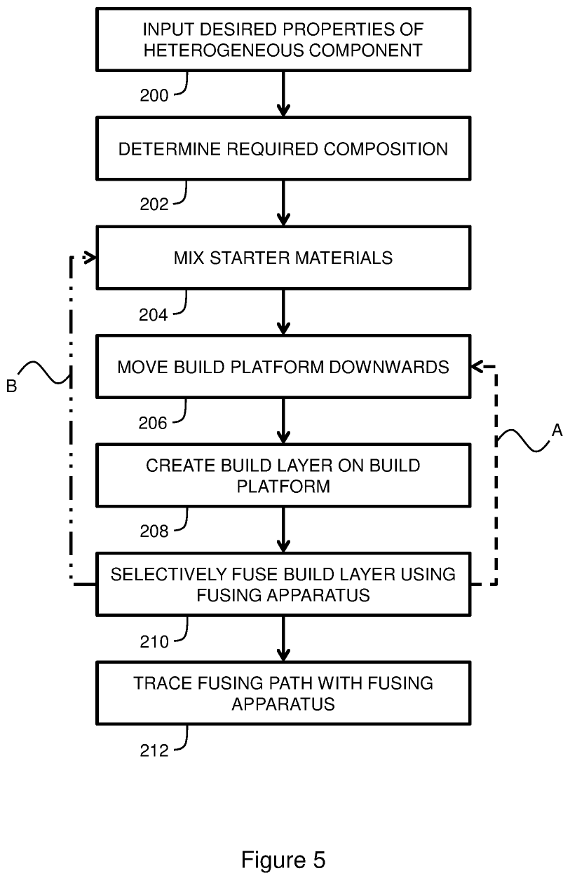

The control unit 100 communicates with both the mixer unit 110 and assembly unit 130 to facilitate the manufacture of components by the additive manufacturing apparatus. The control unit 100 controls various aspects of the operation of the additive manufacturing process, as will be made clearer by the description of an additive manufacturing method below, made with reference to FIG. 5.

In a method for additively manufacturing an item such as a component, desired properties of the finished component are input to the control unit 100, as seen at step 200 of FIG. 5. While the method may be used for a component fabricated from a single heterogeneous material, it may be used particularly effectively for a complex component comprising a plurality of heterogeneous parts, as will be discussed further below. At step 202, the control unit 100 determines the required composition for the component in order to achieve these desired properties, through use of the composition determination system 1 described above. Relevant properties that may be specified extend across physical and mechanical properties of materials and may specifically include the thermal or electrical conductivity of the component.

The required composition is then relayed to the mixer unit 110 by the control unit 100. The control unit 100 causes the required quantity of the necessary starter materials determined by the composition determination system 1 to be transferred from their bays 112 to the mixer module 114, where they are subsequently mixed to produce a first mixed material, as detailed in step 204. The first mixed material is then transferred to the container 120. Based on the required volume of the first mixed material calculated by the control unit 100, the control unit 100 then causes the volume of the container 120 to change depending on the total volume of the first mixed material to ensure that it slightly spills out of the container aperture 140 and onto the interior surface 142 of the base platform 134.

At step 206, the control unit 100 sends a signal to move the build platform 144 downwards in relation to the base platform 134 by an amount that corresponds to the determined thickness of the first layer.

With the first mixed material and build platform 144 in place, step 208 of creating the first build layer on the build platform 144 is implemented. To achieve this, the control unit 100 sends a signal to the coater module 136 to cause it to move across the base platform 134. The coater piece 148 is brought across the container aperture 140, thereby ‘collecting’ the portion of the first mixed material that had spilled out of the container aperture and moving it across the base platform 134 and build platform 144. As the coater piece 148 is moved across the build platform 144, contact is lost between the coater piece 148 and the base platform 144, allowing the first mixed material to fill the build volume 146 such that a first build layer is created, the top of which is level with the rest of the base platform 134. The remainder of the first mixed material that does not enter the build volume and contribute to the first build layer is pushed across to the end of the path of the coater piece 148 and subsequently collected for re-use.

With the first build layer in place on the build platform 144, the method progresses to step 210, where the first build layer is selectively fused by the fusing apparatus 138. The control unit 100 sends a signal to the fusing apparatus 138 with a fusing path and parameters to control the selective fusion of the first build layer. The fusing path defines the shape of the component at the level of the first layer as the powder along the fusing path is fused together. The parameters of the fusing apparatus 138 may require tailoring depending on the exact composition of the powder. For example, in the case of a fusing apparatus 138 in the form of a laser, the laser speed and laser temperature may be altered depending on the composition of the powder; these are both determined by the control unit 100 and may be informed by, for example, the predicted melting point of the determined composition. Once the fusing apparatus 138 has traced the fusing path, a first fused layer is created in the powdered first build layer.

The same process as for the creation of the first fused layer is followed in creating subsequent fused layers. This can be seen by following arrow A in FIG. 5. The control unit 100 ensures the downward movement of the build platform 144 to increase the build volume 146 and allow the accommodation of more of the first mixed material, varies the volume of the container 120 to cause some of the first mixed material to spill out of the container aperture 140, controls the movement of the coater module 136 to spread the first mixed material over the build platform 144 and create a second build layer and controls the fusing path and fusing parameters of the fusing apparatus 138 to selective fuse a second fused layer. The process is repeated with as many layers as is necessary to complete the finished component. In creating the second and subsequent fused layers, it is important to ensure that not only is the mixed material fused within the layer but also that fusion occurs between the subsequent layers to ensure the integrity of the finished component.

In certain cases, it may be desirable for the component to comprise multiple constituent parts with different properties in different constituent parts. For example, it may be desirable for the component to display a specified anisotropy in one or more of its physical and/or mechanical properties across one or more of its regions or directions. In this case, the composition determination system 1 may determine the composition of multiple constituent parts, where each item corresponds to a different section or volume of the component to be manufactured. Where a continuous spectrum of properties is required in one direction, each constituent part may correspond to a single layer of the finished component. In cases where the desired anisotropy lies in more than one direction, a full compositional map may be determined by the composition determination system 1.

If different compositions are required across the component, the control unit, through the composition determination system, will cause different mixed materials to be created over the course of manufacturing the component. As a simple example, for a component that is determined to require 100 layers of mixed material where the first 50 layers are considered to be a first constituent part with a first composition and the second 50 layers are considered to be a second constituent part with a second composition, the first item will be manufactured according to the method described above. The second item will then manufactured on top of the first item, again according to the method described above—this may for example be done by translation to a different work platform if it is difficult to reconfigure the supply system (as can be the case for powder) or simply by adjusting concentrations where this is straightforward (as may apply for other additive manufacturing technologies, for example where the components are provided in a liquid form). This is shown in FIG. 5 by the arrow B returning to step 204 after step 210. This principle can naturally be extended to scenarios where every layer of the component is a distinct item with different compositions. It may even be possible for different items to exist within layers—this may not be supported by all additive manufacturing techniques, but it may be achieved with techniques such as Directed Energy Deposition that have the potential to support in-layer variation. It will be appreciated that the different compositions of different items of the component will require different operational parameters across aspects of the manufacturing process, particularly with regard to the fusing apparatus. This is due to the differing physical properties of materials with different compositions, such as melting points and heat capacity.

Feedback may be provided during the course of manufacturing the component to adjust parameters for later constituent parts, or further layers within a single constituent part, using both performance in manufacturing earlier layers and information from the composition property model. Within a constituent part, previous layers may be assessed to determine whether manufacturing performance was as intended or if properties were as expected—this could require adjustment of operating parameters or even feedback to update the composition property model. However, with a change in composition, the environmental setup—such as laser speed and/or intensity—will typically need to be changed to reflect the different requirements of the material composition at each layer. Specifically, if the composition of the powder changes between the layers, the parameters such as the melting and fusing temperature/pressure might also change in principle—these may be provided as part of the composition property model, as discussed above. There will thus be a need to adjust the laser speed and/or the intensity and other parameters of the build process depending on the layer composition. This is a controllable feature of the process, given the presence of the composition property model and the additive manufacturing unit control processes.

In a specific example, when manufacturing a heat sink, different regions of the heat sink, such as different prongs in communication with different heat sources, may require different thermal conductivities and so require different compositions. The desired thermal conductivities at each location in the heat sink are input to the control unit 100 at the start of the manufacturing process and the composition determination system determines the required composition at each of these locations, designating different constituent parts where different compositions are required. The different items are then manufactured consecutively according to the method above.

This approach allows for more effective component design to meet wider design constraints. For example, heat sink prongs in an aircraft may be required to act as a heat sinks from different engine parts, but it may have additional design constraints, such as dimensional constraints, in the light of aerodynamic properties required. A heat sink prong for a rotor may need to manage different thermal transfer than from a fuel pump, but for aerodynamic reasons the heat sink prongs may need to have the same dimensions while having different heat conducting capacity. This could be achieved by a compositional map which provides for constituent parts (layers) near the rotor having higher conductance than constituent parts near the pump, for example.

It will be appreciated by the skilled person that, although the interaction between the composition determination system 1 and the additive manufacturing apparatus has been described here as being through a control unit, that other ways of incorporating the composition determination system 1 into the working of the additive manufacturing apparatus are possible. More generally, the skilled person will appreciate that many further embodiments are possible within the spirit and scope of the disclosure set out here.

1. A method of additive manufacture of a constituent part of an item, comprising:
providing a specification of characteristics for the constituent part;
using a composition determination system, wherein the composition determination system is a system trained using a database of known materials to identify a composition comprising a plurality of component materials predicted to comply with the specification of characteristics; and
manufacturing the constituent part of the item according to the composition identified by the composition determination system using an additive manufacturing system.

2. The method as claimed in claim 1, wherein for the composition identified for manufacturing the constituent part, further materials properties are established by the composition determination system, and wherein these further materials properties are used for determining settings for the additive manufacturing system

3. The method as claimed in claim 1, wherein the item comprises a plurality of constituent parts, wherein the method comprises identifying the composition for each of the constituent parts and manufacturing each of the constituent parts of the item according to the composition identified for that constituent part.

4. The method as claimed in claim 3, wherein the item is manufactured in a plurality of layers, with each constituent part forming one or more of the layers.

5. The method as claimed in claim 3, wherein the item is a component.

6. The method as claimed in claim 5, wherein the component is a heatsink.

7. The method as claimed in claim 1, wherein the additive manufacturing system comprises a mixer for mixing the component materials in proportions according to the composition, and a fusing technology for fusing the component materials to form an item.

8. The method as claimed in claim 1, wherein the additive manufacturing system is adapted to feedback properties of manufactured constituent parts in relation to predicted properties for those constituent parts into determining settings for the additive manufacturing system for manufacturing future constituent parts.

9. The method as claimed in claim 1, wherein the composition determination system is trained using one or more machine learning methods.

10. A method of establishing a computer-implemented composition determination system for manufacture of items, the method comprising:
establishing a materials database where each entry comprises a material composition from a set of component materials and associated properties for the material with that material composition;
using a machine learning system to train a composition property model using data from the materials database;
testing the composition property model using data from the materials database;
optimising the composition property model until it is adapted to predict associated properties for an arbitrary material composition; and
establishing a user interface for determination of a composition of a constituent part of an item using the composition property model for input values for properties of that constituent part.

11. The method as claimed in claim 10, wherein optimising the composition property model comprises adjusting the hyperparameters of the model.

12. The method as claimed in claim 10, wherein optimising the composition property model comprises further training and testing the composition property model using data from manufactured items.

13. A control system for additive manufacture of an item using heterogeneous materials by an additive manufacturing system, the control system comprising:
a composition input for receiving a composition of component materials for one or more constituent parts of the item and a set of associated properties for the composition from a composition determination system, wherein at least some of the associated properties are specified properties for the constituent part or parts of the item;
a materials output for instructing provision of the component materials for provision to a mixer of the additive manufacturing system in accordance with the composition; and
setting determination means adapted to determine settings of the additive manufacturing system based on the composition and the associated properties for the composition, and to provide those settings as an output to the additive manufacturing system.

14. The control system of claim 13 further adapted for additive manufacture of an item comprising a plurality of constituent parts, wherein the setting determination means is further adapted to adjust settings of the additive manufacturing system based on differences between the composition and associated properties of the composition of the current constituent part and the composition and associated properties of the composition of a preceding constituent part.

15. The control system of claim 14, wherein the setting determination means is further adapted to adjust settings of the additive manufacturing system based on a difference between actual associated properties and predicted associated properties of an constituent part manufactured by the additive manufacturing system according to a composition received from the composition determination system.

16. The method as claimed in claim 11, wherein optimising the composition property model comprises further training and testing the composition property model using data from manufactured items.

17. The control system of claim 15, wherein the setting determination means is further adapted to adjust settings of the additive manufacturing system based on a difference between actual associated properties and predicted associated properties of an constituent part manufactured by the additive manufacturing system according to a composition received from the composition determination system.
